(19) United States
(12) Patent Application Publication
(10) Pub. No.: US 2021/0368304 A1
(43) Pub. Date: Nov. 25, 2021

(54) WORKFLOW TRIGGER FEATURE USING TEXT MESSAGE AGGREGATION

(71) Applicant: Deepak Marwah, Takoma Park, MD (US)

(72) Inventor: Deepak Marwah, Takoma Park, MD (US)

(21) Appl. No.: 16/881,031

(22) Filed: May 22, 2020

(51) Int. Cl. H04W 4/14; G06F 9/50; H04L 12/58

(52) U.S. Cl. CPC H04W 4/14; H04L 51/10; G06F 9/5005

(57) ABSTRACT

A system and method are disclosed for enhancing the capabilities of mobile devices using only text messaging applications and protocols to access servers and other computing resources that perform analysis, decision-making, and workflow processing without the need for web browsers or custom applications on the mobile devices.

### BACKGROUND OF THE INVENTION

### 1. Field

The present invention relates generally to an enhanced text messaging capability used for distributed computing in the field of communications.

### 2. Description of the Related Art

Text messaging is a widely used communications service that enables the transmission of text and/or multimedia messages between communications devices. Nearly half of all cell phone users in the world do not own a smartphone, which makes text messaging the universal application with which users can receive and transmit data and information. Texts are typically not carried on fixed broadband networks; in contrast, these messages are commonly delivered over cellular networks.

The prevalence of basic phones, that is, phones with limited applications and/or applets and no ability to install other applications, in contrast to smartphones, and bandwidth are both limiting factors to the accessibility of intensive computing capabilities. Increased memory and data storage are both required to support the significant processing and information sharing found on today's smartphones. Currently, basic phones can only use Short Message Service (SMS) text messaging to exchange information, and text messaging is conventionally used for conversational purposes. Basic phones often do not support web browsing over Hypertext Transfer Protocol (HTTP) as basic phones often do not support cellular Internet connectivity, have limited processing capabilities by design, or use phone plans for ‘Talk and Text’ only. Regardless of a user's phone type, rural areas provide limited cellular bandwidth, which makes text message the only mechanism to send and receive information when bandwidth is limited. Currently, the most complex use of text messaging is limited to transactions with individual businesses that use SMS to collect information from individuals to confirm appointments or engage in a transactional conversation with a recipient such as a buyer of a product or service. The methods and systems disclosed herein are an improvement upon this existing technology in that it extends the use of SMS and other text messaging technologies, integrating a phone number or other messaging identifier with computing capabilities to serve as a host computer or server to mobile devices; enabling mobile devices to act as thin clients connected to servers; and leveraging a data repository as well as constraints to process multiple text message responses for the purpose of making intelligent decisions and performing workflow processes in response. The inventions disclosed herein are novel because they provide an ‘App-less’ capability that extends intelligent data operations to all persons with any mobile device with some form of text messaging, improving and extending the capabilities of a text message interface. This capability reduces the mobile computing resources and bandwidth required to access sophisticated server operations by harnessing processing power on a host through the specific unconventional arrangement of components, phone numbers or other text messaging identifiers, networking, mobile devices, and computing capabilities.

The invention provides a universal ability—by using any device with a text messaging capability—to collect and act on information from mass audiences. This invention is particularly important for real-time or near real-time crisis response situations when right-sizing a rapid response is required from all mobile device users, not just those with access to smartphones.

Conventional technology systems used for planning and executing operations typically involve the use of web-based applications or smartphone applications to engage with customers and process transactions. Because most business systems today rely on these interfaces, their inherent flaws make it challenging to engage large audiences that do not have access to smartphone or web capabilities. Text messaging is the only universal application for processing data to and from all potential recipients, and the invention herein describes how text messaging can be used in an unconventional manner for real-time or near real-time decision making, resource allocation, and automated communication based on human responses. Additionally, the capability can be used to collect geographical information from users, enabling real-time or near real-time mapping of response generation.

While conventional ticketing methods may be adequate for managing participant size for planned events such as concerts and sporting events, they are not adequate or efficient for time-constrained needs. For example, emergency response has both specific capacity needs and time constraints that require the organizers to have both a minimum and a maximum number of targeted participants. Right-sizing events often require that the planning operation be conducted quickly, such as emergency response, with minimum time between the issuer's request and the responses. Right-sizing events require a high degree of accuracy, enabling workflow enrollment related to the respondents/attendees for a given activity. Otherwise, the operation runs the risk of failing by not meeting criteria thresholds such as having too few or too many attendees or respondents for a given activity. (e.g., too many or too few emergency responders).

There are several problems in the prior art of both collecting and acting upon data collected from mobile users. First, significant computing resources are required on mobile devices to process large amounts of information across a network. The digital divide excludes those that do not own smartphones from accessing distributed computing capabilities. Second, significant bandwidth is required to send and receive data for application processing from conventional smartphone applications. Third, the prior art of text messaging, such as SMS, was aimed at conversational text, appointment confirmations, and responding to surveys, not an I/O interface for the collection and processing of real-time data from large audiences. Fourth, the prior art of smartphone computing capabilities required significant exposure to personal data and information due to the inherent nature of smartphone applications.

What is needed is a revolutionary new approach to reduce the compute power and bandwidth required to enable real-time computation of data from multiple users and to support decision making, resource allocation, and automated communication. This approach enables issuers to request and exchange real-time information from multiple mobile device users regardless of the capabilities of the device or operating system by using text messaging as an I/O interface. This approach enhances the current text messaging interface by introducing capabilities traditionally found on smartphones.

### SUMMARY OF THE INVENTION

The following is a non-exhaustive listing of some aspects of the present techniques for increasing efficiency of collecting and acting upon real-time and near real-time data from a group of mobile device users. These and other aspects are described in the following disclosure.

It is apparent that a need exists for a feature that enables universal access to distributed computing, whereby aggregated text message responses can be analyzed and acted upon in real-time or near real-time based on information from respondents to trigger workflows related to the event need. It is an object of the present invention to provide a method and a system for a client-server (host) architecture that allows mobile devices to become thin clients enabling criteria-based execution of workflow based on text message-based responses. The technical architecture and workflow trigger feature address a need for analyzing and acting upon massive volumes of text messages in real-time or near real-time, enabling the technology required to organize, aggregate, and act upon information across all types of mobile device users.

The inventions disclosed herein include a method and system for a mobile client-server architecture and associated workflow trigger feature using the aggregation of text message responses, and more particularly a method and system for automating the execution of a workflow module based on the responses of text messages from multiple individuals (e.g., event registration, planning and disaster response) and a criteria-based threshold. Location information may also be collected as part of a response, which could be used for rapid response based on the geographical information provided by the user. The capability could also be implemented as an extension to existing text messaging technologies such as SMS, Multimedia Messaging Service (MMS), Rich Communication Services (RCS) or Over-the-Top services (OTT) as well as integrated into mobile applications.

As used herein, an issuer is the person or entity requesting information from a target audience, known as recipients or respondents herein, using mobile devices. The issuer initiates contact to respondents with a text message-based question or action, which is not a conventional group text as is known in the art; rather, it is a single text message per respondent issued from a phone number owned/operated by the issuer. The respondents would then respond to the issuer only with a response based on the issuer's question or request.

The text message aggregation feature disclosed herein involves a method for storing and analyzing text messages for data quality to verify response information using an analysis module. The data within each text message is stored in a repository enabling analysis of the data set. The text messages would be compared against variables as the messages are submitted in real-time and near real-time and assessed to determine if the responses meet one or more pre-determined criteria thresholds, described herein as the decision module. Using the decision module, if the aggregation meets the one or more criteria thresholds specified by the issuer, the invention triggers one or more workflow operations through a workflow module, which includes, but is not limited to, a summary report to the issuer, communications back to the respondents, and potential integration of third parties for additional communication/activity such as payment processing.

An embodiment of the invention disclosed herein may be used to process payment and financial transactions automatically based on the content of the text message response. As an example, assuming the issuer has extended the inventive method and system to store payment information of respondents in its domain, the issuer could automatically initiate a workflow to process payment based on a positive response from the respondent. For sports events, concerts, and other events where capacity minimums and maximums are required, this embodiment would enable the processing of ticket purchases when a buyer responds affirmatively to a text messaging request to attend an event while continually monitoring ticket issuance within venue capacity constraints.

The invention disclosed herein includes a method and system for operational planning using the aggregation of text messages (e.g., SMS/RCS), and more particularly a method and system for initiating workflow triggers based on the responses of text messages from multiple individuals (e.g., crisis response/planning). Users of this method and system would be able to automate the execution of workflows based on the information received by multiple individuals including, but not limited to, a summation, statistical analysis, location, and emotion (emoji) based analysis from the text message responses. It also provides a low-bandwidth method to collect and act on information from mass respondents, which can be critical in a crisis. Furthermore, text messaging services typically enable store and then forward messaging, which does not require ongoing processing and network connectivity to transmit data like HTML over HTTP does. If a text message recipient's phone is out of range or turned off, the sent text message will be queued and stored until it can be delivered, which can be in hours or even days.

This capability enables a more private, secure communication channel to engage mobile device users in contrast with apps today that track user information for advertising and other purposes. Users would be able to control location data that is transmitted in this method and system, maintaining the privacy of respondents. This method and system could also be used by children for attendance or other related purposes, and by inherently limiting private information used in the service, the capability complies with the Children's Online Privacy Protection Act (COPPA). The invention requires only a phone number of the respondent to be functional and can be extended as needed to employ additional workflow and communication methods such as email, voice, etc. These and other advantages of the invention disclosed herein will be apparent to those of ordinary skill in the art by reference to the following detailed description and the accompanying drawings.

Some aspects include a method for computing information collected from text message responses performed by devices with processing capability, that is, any device that contains a CPU, microprocessor, microcontroller, field-programmable gate array (FPGA), application-specific integrated circuit (ASIC) or other integrated circuit able to execute instructions implementing the invention. As non-limiting examples, such devices include computing devices, such as a desktop computer, notebook computer, server, tablet, phone, smartphone, personal digital assistant (PDA), and other mobile device.

Some aspects include a tangible, non-transitory, machine-readable medium storing instructions that when executed by a data processing apparatus cause the computing apparatus to perform operations including the above-mentioned method.

Some aspects include a system, including: one or more processors; and memory storing instructions that when executed by the processors cause the processors to effectuate operations of the above-mentioned method.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 depicts an exemplary computer system by which some embodiments are implemented.

FIG. 2 depicts a network diagram with exemplary computing systems by which some embodiments are implemented.

FIG. 3 depicts the mobile-based, client-server architecture by which some embodiments are implemented.

FIG. 4 depicts a schematic diagram of the text message-based aggregation of responses and steps required to trigger an associated workflow.

FIG. 5 is a logical diagram of the text message-based aggregation of responses depicting the issuer and recipients/respondents and the steps required to trigger an associated workflow.

FIG. 6 is a block diagram that depicts an embodiment of the present invention containing an illustrative database that could be used for extending the present invention such that text responses facilitate associated financial transactions based on stored user information.

FIG. 7 depicts a mobile computing system by which some embodiments could be extended to be used in existing mobile devices to serve as hosts that send ‘Cast Net’ messages, which request information from recipients.

FIG. 8 depicts a mobile computing system for recipients and how recipients would respond within the text messaging interface.

FIG. 9 depicts the interaction the recipients could use to access the distributed information collected from all recipients. As data is collected from the invention described, recipients would be able to use the text messaging interface as an I/O interface to query in real time the information via command or natural language processing.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventor had to both invent solutions and, in some cases just as importantly, recognize problems overlooked (or not yet foreseen) by others in the fields of communications and mobile applications. Indeed, the inventor wishes to emphasize the difficulty of recognizing those problems that are nascent and will become much more apparent in the future should trends in industry continue as the inventor expects. Further, because multiple problems are addressed, it should be understood that some embodiments are problem-specific, and not all embodiments address every problem with traditional systems described herein or provide every benefit described herein. That said, improvements that solve various permutations of these problems are described below.

The present invention solves a long-standing challenge in efficiently right-sizing events via standard mobile communication protocols such as SMS: how to use the information in mobile applications to provide distributed computing power to all mobile device users, not just those users with more advanced mobile devices like smartphones. Prior to the inventions described herein, there has been an inability to enable non-smartphone users to harness computation of real-time information from other mobile device users. The embodiments described herein provide a highly automated and efficient manner to collect, act upon, and access real-time information across all types of mobile device users.

The text message aggregation feature disclosed herein involves a method for storing and analyzing text messages for data quality to verify response information though an analysis module. The data within each text message is stored in a repository enabling analysis of the entire data set of responses. Using an analysis module, the text messages are compared against variables as the messages are submitted in real-time and near real-time. Using the decision module, if the aggregated responses meet the one or more criteria thresholds specified by the issuer, the invention triggers the workflow module operations, which include but are not limited to a summary report to the issuer, communications back to the respondents, and potential integration of third parties for additional omni-channel communication/activity.

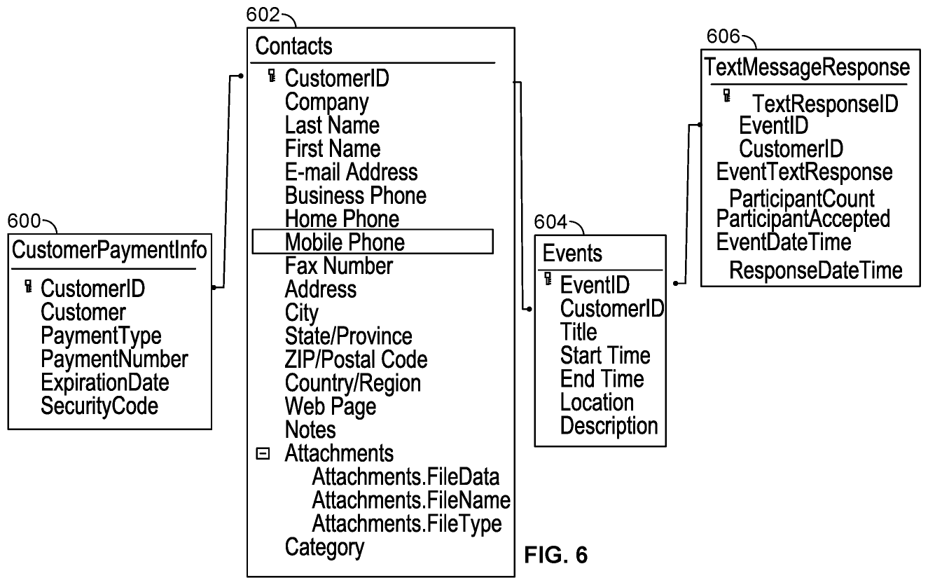

An embodiment of the invention disclosed herein may be used to process payment and financial transactions automatically based on the content of the text message response. As an example, assuming the issuer has extended the inventive system to store payment information of respondents in its domain, the issuer could automatically initiate a workflow to process payment based on a positive response from the respondent. For sports events, concerts, and other events where capacity minimums and maximums are required, this embodiment would enable the processing of ticket purchases when a buyer responds affirmatively to an SMS request to attend an event. FIG. 6 below describes an exemplary repository used by this embodiment of the invention.

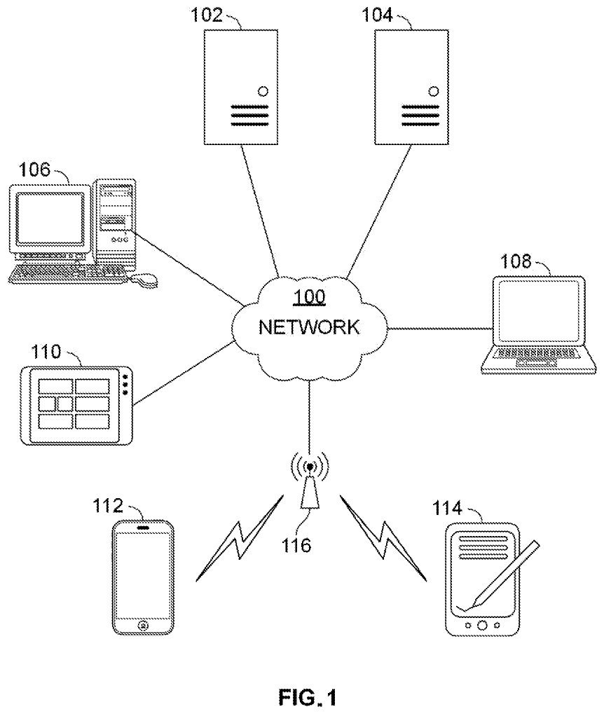

FIG. 1 is a network diagram that illustrates exemplary computing systems in communication with one or more computing systems in network 100 to implement enhanced security systems in accordance with embodiments of the present technique. Various portions of the systems and methods described herein may include implementation on one or more computing systems depicted in network 100. For example, it is contemplated that the invention can be implemented completely on any exemplary device depicted in FIG. 1, including server computers 102 and 104, desktop computer 106, notebook computer 108, tablet 110, smartphone 112, or personal digital assistant (PDA) 114. However, the invention may also be advantageously implemented on two or more of the exemplary devices depicted in FIG. 1. Although the network 100 is depicted without detail of specific network implementations save for wireless access point 116, those skilled in the art should understand that the invention is not limited by any particular network configuration, and indeed the invention is flexible enough to be implemented in the context of any network type or configuration, including local area networks (LAN), wide area networks (WAN), personal area networks (PAN), and wireless networks of various types including LANs, WANs, and PANs. For example, in a client-server embodiment, any of client devices comprising desktop computer 106, notebook computer 108, tablet 110, smartphone 112, or personal digital assistant (PDA) 114 can implement any part of the invention described herein, with the remainder of the invention implemented on either or both server computers 102 and 104. In one embodiment, server computers 102 and/or 104 communicate directly with the mobile devices of one or more respondents. Those skilled in the art will appreciate the myriad configurations and scenarios of both devices and networks possible with the invention, all of which are intended to be within the spirit and scope of the invention.

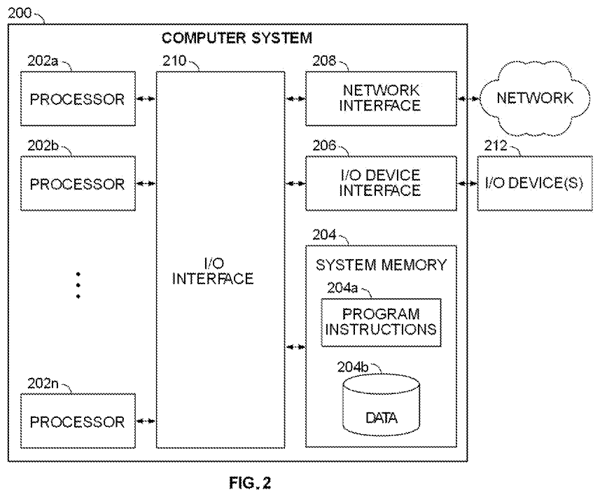

FIG. 2 is a diagram that illustrates an exemplary computing system 200 in accordance with embodiments of the present techniques. Various portions of systems and methods described herein, may include or be executed on one or more computer systems like computing system 200. Further, processes and modules described herein may be executed by one or more processing systems like that of computing system 200.

Computing system 200 may include one or more processors (e.g., processors 202a-202n) coupled to system memory 204, an input/output I/O device interface 206, and a network interface 208 via an input/output (I/O) interface 210. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 200. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 204). Computing system 200 may be a uni-processor system including one processor (e.g., processor 202a), or a multi-processor system including any number of suitable processors (e.g., 202a-202n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 200 may include a plurality of computing devices (e.g., distributed computer systems) to implement various processing functions.

I/O device interface 206 may provide an interface for connection of one or more I/O devices 212 to computer system 200. I/O devices may include devices that receive input (e.g., from a user) or output information (e.g., to a user). I/O devices 212 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 212 may be connected to computer system 200 through a wired or wireless connection. I/O devices 212 may be connected to computer system 200 from a remote location. I/O devices 212 located on a remote computer system, for example, may be connected to computer system 200 via a network and network interface 208.

Network interface 208 may include a network adapter that provides for connection of computer system 200 to a network. Network interface 208 may facilitate data exchange between computer system 200 and other devices connected to the network. Network interface 208 may support wired and/or wireless communication. The network may include an electronic communication network, such as the Internet, a local area network (LAN), a personal area network (PAN), a near field communication network (NFC), a wide area network (WAN), a cellular communications network, or the like.

System memory 204 may be configured to store program instructions 204a or data 204b. Program instructions 204a may be executable by a processor (e.g., one or more of processors 202a-202n) to implement one or more embodiments of the present techniques. Instructions 204a may include modules of computer program instructions for implementing one or more techniques described herein regarding various processing modules. Program instructions may include a computer program (which in certain forms is known as a program, application, software, software application, applet, plug-in, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 204 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 204 may include a non-transitory computer readable storage medium that may have program instructions stored thereon that are executable by a computer processor (e.g., one or more of processors 202a-202n) to cause the subject matter and the functional operations described herein. A memory (e.g., system memory 204) may include a single memory device and/or a plurality of memory devices (e.g., distributed memory devices).

I/O interface 210 may be configured to coordinate I/O traffic between processors 202a-202n, system memory 204, network interface 208, I/O devices 212, and/or other peripheral devices. I/O interface 210 may perform protocol, timing, or other data transformations to convert data signals from one component (e.g., system memory 204) into a format suitable for use by another component (e.g., processors 202a-202n). I/O interface 210 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 200 or multiple computer systems 200 configured to host different portions or instances of embodiments. Multiple computer systems 200 may provide for parallel or sequential processing/execution of one or more portions of the techniques described herein.

Those skilled in the art will appreciate that computer system 200 is merely illustrative and is not intended to limit the scope of the techniques described herein. Computer system 200 may include any combination of devices or software that may perform or otherwise provide for the performance of the techniques described herein. For example, computer system 200 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 200 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 200 may be transmitted to computer system 200 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

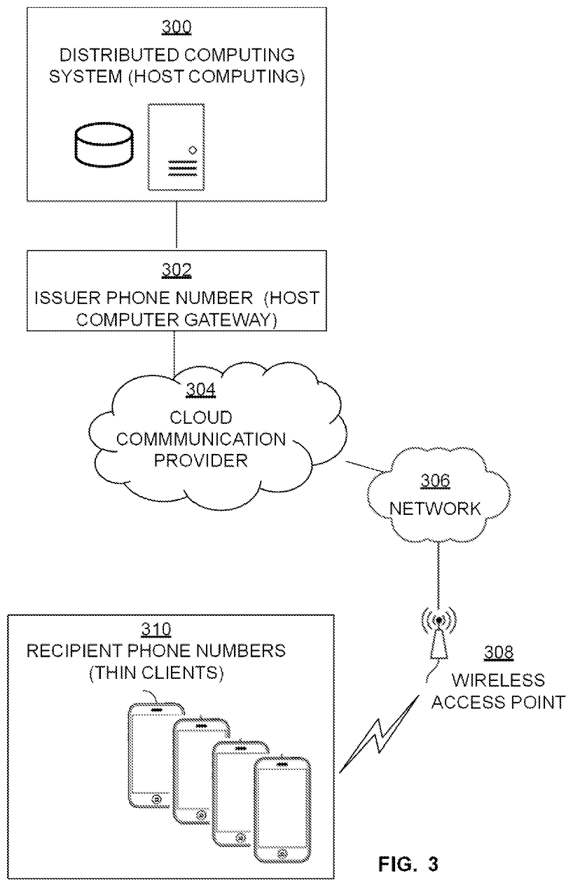

FIG. 3 is an architectural diagram that illustrates exemplary computing systems in a client-server architecture to implement the arrangement of computing, mobile devices, and networks in accordance with embodiments of the present technique. FIG. 300 describes the host computer, which includes a 2-tiered architecture with an application and database tier, where the bulk processing of text messages would be analyzed and stored. The application tier includes features that trigger additional workflow, and the database tier is the storage location for the bulk text messages and associated analyses. An Issuer would use this host to initiate communication to mass audiences with no limit as to the number of recipients. FIG. 302 illustrates the Issuer phone number, which is the gateway/address to the host computer. FIG. 304 illustrates the cloud communication provider that provides the interface between the phone number and a standard computer network as illustrated in FIG. 306, enabling the data to be transmitted to and from the standard computing network and the host computer. FIG. 308 illustrates the wireless access point, which would serve as the interface between the standard computing network and the requisite cellular capabilities to reach the ‘thin clients’—the mobile devices in accordance with embodiments of the present technique. FIG. 310 illustrates the mobile devices, which could include basic phones and/or smartphones—any device with a text message interface. The devices represented in FIG. 310 would serve as thin clients in the client-server architecture described herein.

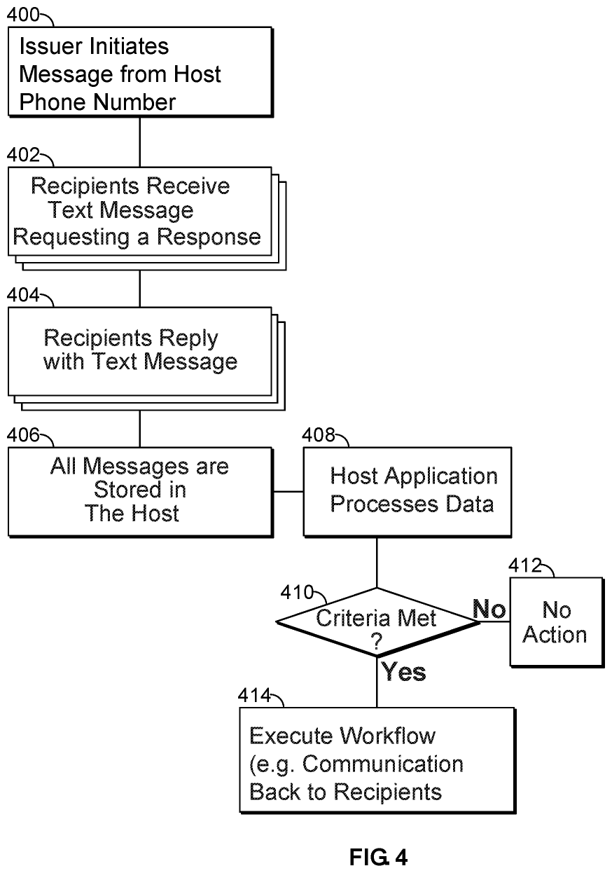

FIG. 4 depicts a text message aggregation system in accordance with the present invention. An issuer issues a text message using the query module (e.g. a survey, attendance request, etc.) requesting a response in step 400. The message is routed to each respondent individually requesting a response from the recipient in step 402. In step 404, each recipient responds to the information request, and these responses are aggregated and stored in a repository in step 406. As the text message responses are stored into the repository, using the analysis module, there is an ongoing calculation of the responses in step 408. Based on the calculation of affirmative text messages responses (e.g., issuer determines whether minimum and maximum participation thresholds are met), the subsequent one or more workflow action(s) are performed in step 410 using the decision module. If the one or more thresholds are not met (e.g., minimum participation threshold is not met), then there is no action taken as shown in step 412 and the invention continues processing other responses. If the one or more thresholds are met (e.g., minimum participation threshold is met and does not exceed maximum participation threshold), then the workflow module is initiated in step 414 triggering workflows based on the analysis of the responses and the requirements of the issuer.

The preferred embodiment is aimed at opportunities where real-time or near real-time responses from people automatically trigger one or more workflows. For example, concert venues that would like to pre-sell tickets through text messages in accordance with the invention may require a minimum and a maximum participation along with a set time frame, which could be set to minutes as opposed to hours, or hours instead of days. Using this method of the invention, concert organizers issue a text message to a list of potential participants (assuming the organizers have a potential participant database from past concerts) to pre-sell a finite number of tickets that meet all the thresholds and requirements of the issuer.

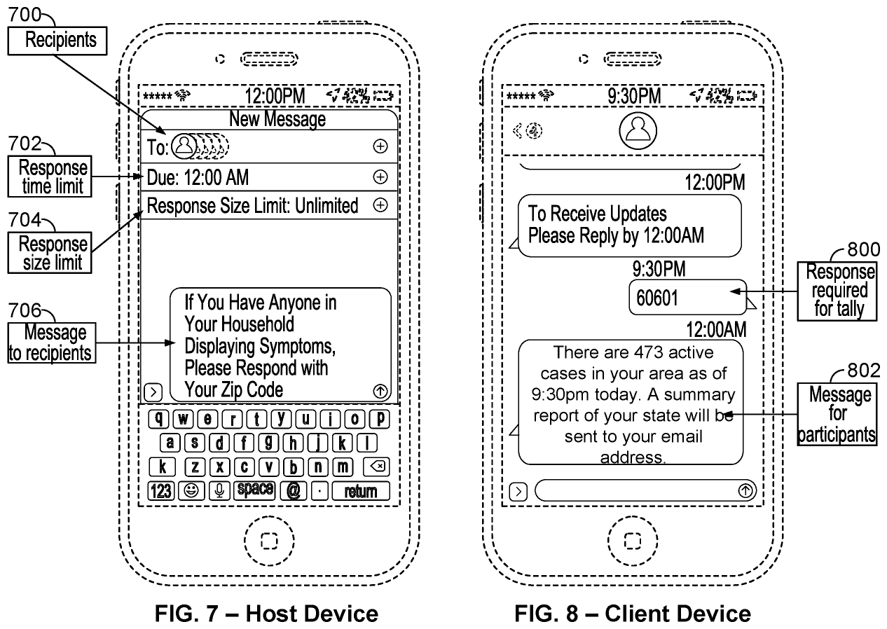

The inventive method and system may enhance a part of existing messaging platforms, described in FIG. 7, using a Cast Net Message of the present invention. A Cast Net message is the message sent to a target group of mobile phone numbers with a specific request for information from those users. Recipients of the message input a response to the message, and these responses are stored in real-time while concurrent computations are run against the information collected. The invention enables the issuer to leverage text message-based responses to continually monitor the incoming responses and automate a response to participants. This response could include geographical information based on the responses or a summary of affirmative responses based on the question asked. In the illustrations from FIGS. 7 and 8, the embodiment provides a duration by which respondents could answer the question followed by one or more automated workflows that distribute geographical mapping based on the aggregated response information. This embodiment provides real-time and near-real time access to information from a distributed population without requiring a smartphone or significant bandwidth used by mobile devices. This embodiment includes the capability to issue Cast Net messages to millions of recipients, enabling large-scale distributed computing based on real-time responses.

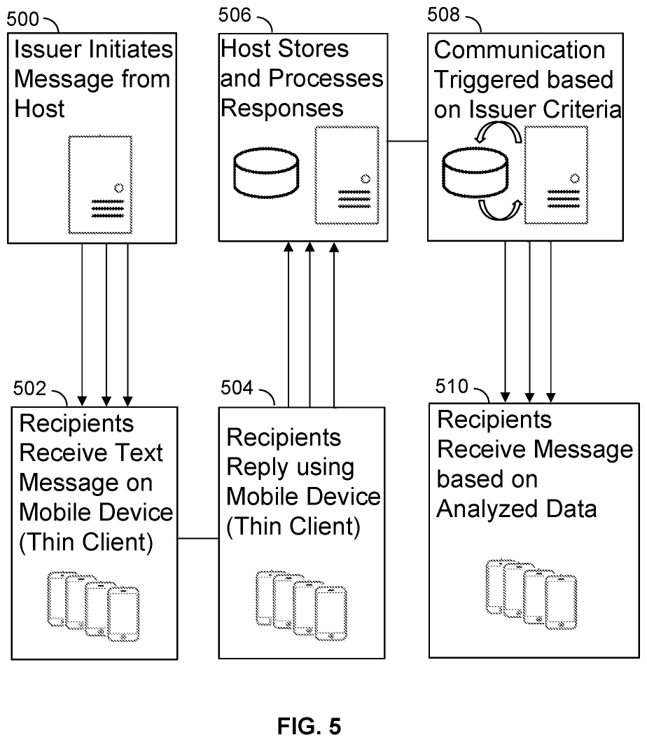

FIG. 5 is another exemplary embodiment of text messaging operations in accordance with the invention. An issuer requests a response in step 500. As an example, a small concert venue may desire to poll potential audience members to see if they are interested in buying tickets to a show that evening with a limit of 50 participants total. The issuer could send a Cast Net message using the query module, as shown in Step 500 to a target group of mobile users. The recipients receive the message in step 502. In this example, recipients would receive the message asking them if they would be interested in the concert, showing the quantity limit of 50 attendees. The recipients respond with a reply in step 504 based on this question, providing input back to the issuer. As responses are collected from recipients, they are stored in the order received using the time stamp of the data collection. This feature enables the issuer to identify the first 50 people to respond affirmatively to the question posed. In step 506, the messages are stored in a database where ongoing computation is performed in real-time shown in step 508 using the analysis module. In this example, the computation performed is analyzing the response data for affirmative or negative responses to the question. The first fifty affirmative responses would trigger one or more subsequent workflows because the limit of participants was reached. The decision module is shown in step 508, which triggers the workflow module in step 510. In this example, the one or more workflows include text message replies to all recipients based on the information processed. If the one or more criteria are not met, then processing of other responses continues until the limit is reached or the time allotted for the decision to be made is reached.

The method and system shown in FIG. 5 may also be implemented as a part of existing messaging platforms, described in FIG. 7 a Cast Net Message. The existing messaging platforms may be extended to integrate features described herein for individuals to self-organize events where capacity limits exist or where there is a need to tally a large group for survey purposes requiring real-time analysis. For organizing attendance to events, the existing applications may be extended to include additional parameters such the response required (e.g., “numeric”), the response time limit (e.g., “12 hours”), participant limit (e.g., “10”), and the message for confirmed participants (e.g., address/location of the event). An embodiment can include a configuration of a Cast Net message that requests a specific response such as ‘Yes’ or ‘No’, which can be used to expedite the criteria-based computations. If a participant limit is set based on the message or question to recipients, the message can be tailored to those confirmed for the event based on the participant limit. As an example, campaign events which have short lead times for planning and are based on venue sizes can use text messaging to reach large audiences and issue tickets to the recipients based on the timestamp before the participant limit is reached. Additional configurations of the Cast Net Message can include replies recipients receive following their response submission as shown in FIG. 8.

FIG. 6 depicts a depicts an exemplary, non-limiting database schema that can be used in the present invention. While the present invention is aimed at collecting minimal information from respondents, the invention may be extended with a data store to facilitate associated financial transactions based on stored user information. In step 600, customer payment information is stored. In step 602, an expanded collection of information about the recipients would be stored. In step 604, information about the event that is being tracked (e.g., a concert) would be stored. In step 606, the message responses by the recipients could be stored for calculations and analysis. All of this information may be stored for long term use and reuse for future event management. By including recipient payment information, the text message responses can be converted immediately into financial transactions that can be issued for the user. These transactions can be confirmed in real time with the user and payment information processed immediately based on the text response.

Other embodiments of the database can extend the capability of the invention for 1) financial transactions, 2) inventory management, 3) personnel management, and 4) real-time survey monitoring. In a financial transaction embodiment, if respondents agree to attend the concert by replying affirmatively to the concert organizer's request via text message, the concert organizer could automatically process payments based on affirmative responses from participants. Similarly, this method could be used for distributing or auctioning goods/services that have a finite quantity where the demand is assessed in real-time or near-real time against one or more pre-determined criteria. Another embodiment includes finding the right number of human resources for a specified activity. For example, an issuer can request a finite number of people to help ship goods to residences and receive responses from willing participants in real time. This embodiment would help solve the “last-mile” problem in shipping and/or humanitarian relief efforts which require real-time human resource management. By using the invention, an issuer can reach out to a pool of resources in a local area to see who is available to support the shipment of goods to local residences—the issuer would be able to find just the right amount of human resources. As shown in FIGS. 4 and 5, an exemplary application of the invention includes the collection of information based on disease monitoring. If enabled, the database can be extended to include additional health care information for recipients, which may help provide enriched healthcare services based on the enhanced patient information received from the respondents.

FIG. 7 depicts how a messaging platform on a smartphone can be enhanced to serve as the host computer that collects information through a Cast Net message. In the example from FIG. 7, the issuer, using the query module, asks a list of targeted recipients whether or not they are displaying symptoms of a disease. In this example, the recipients could be a statistical sample population of targeted participants from across the country. The issuer can request specific information from recipients. In this example, the issuer is requesting the Zip Code from the recipients. In step 700, the targeted list of recipients that would receive the message shown. In step 702, the requested time for recipients to respond to the message is shown. In this example, recipients of the message would have until midnight to respond to the question. In step 704, the response size limit is requested, which can range from 1 to a larger number, or may be unlimited. In this example shown in FIG. 7, there is no limit requested, which allows responses to be processed by the analysis module until midnight the day the issuer sends the Cast Net message. In step 706, the issuer's query is shown on the host mobile device. This message is sent to all recipients along with the time the response is due. Recipients must respond within that time window to have their message considered as a part of that workflow. In this example, all of the recipients would have to respond by midnight to have their zip code included in the tabulation. The time limit for the Cast Net message would trigger the workflow at midnight, initiating the workflow communication to recipients of the Cast Net message. In this example, the recipients would receive the current mapping of the epidemic based on participant response.

As an example of conventional techniques, Apple and Google are building apps to support contact tracing and communication. While these proposed apps and protocols could support some parts of contact tracing, they are not capable of inherent interoperability of the invention described or the more sophisticated capability to interview subjects en masse—those with and without access to smartphones, identify clusters of infection based on information collected from a broad range of mobile users, and issue automated responses and alerts in real time. Moreover, the different, incompatible mobile application ecosystems of Apple and Google are an example of the prior art's inability to provide the universal benefits of the present invention.

A preferred embodiment is a method by which an issuer can craft a question to be sent to multiple recipients with enough information to initiate one or more workflows based on the text message responses collected. This embodiment can employ either a web-based interface or a text messaging interface on a mobile device. In this embodiment, a specific response is needed from the user to trigger one or more workflows (e.g., one hundred people need to answer ‘Yes’ to initiate a workflow that a concert will be held). This embodiment is preferred when it is unknown whether there will be enough interest in an event, and a minimum number of people is required to hold the event.

FIG. 8 depicts how recipients with client devices, such as basic phones, can receive the text request issued from in the embodiment depicted in FIG. 7. Recipients receive the question along with the due date/time for a response. Recipients respond to the question as shown in step 800. An automatic, computed reply would be provided to the user based on the issuer's configuration. In step 802, this computed reply is shown to the recipient as well as the notification of subsequent workflow to occur and how they can expect to receive additional information based on their and other participants responses.

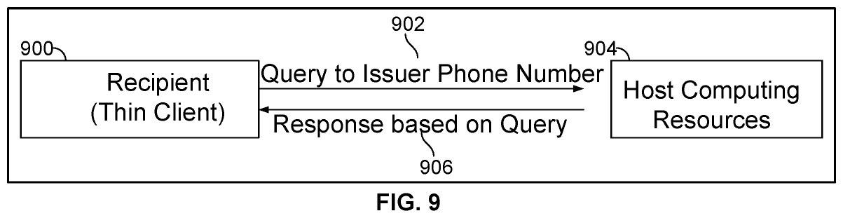

FIG. 9 depicts how recipients can engage with the database throughout the data collection process to request information in real-time. In step 900, the recipient could issue a text message to the issuer phone number requesting information using natural language or queries. Based on the epidemic example, a mobile user could request information on the latest number of households displaying symptoms of the virus for a specific zip code (e.g. “Question: How many households are infected in Zip Code 60601?”). The query triggers computations against the database to pull the latest information and present it back to the recipient in real time. This type of query is depicted in step 902, and the database is shown in step 904. The response is shown in step 906, which is the intelligent processing of the query and the return of the information to the user through the text messaging interface. This capability enables the text messaging interface to serve as a thin client for accessing real-time, distributed information across mobile users.

In another embodiment, users may submit a query in a natural language expression to retrieve information about an event. The database along with computational capabilities enables intelligent interpretation of questions as they are applied against the running database of recipient responses. An alternative embodiment ties the information in the database associated with the recipient responses to larger databases such as geographical information, farming information, scientific information, and other datasets that can provide information back to the user with broader context. As shown in FIG. 8, epidemic responses can be overlaid with geographical information and maps to show real-time responses across areas of varying geographic scope, such as cities, counties, states or an entire country or region.

An alternative embodiment of the invention disclosed herein is use of machine learning in the analysis of the text messages to trigger specific workflows related to the responses. The message header, signaling information, or the message itself may be provided to the issuer or designated third parties to provide additional insight on the respondents, which can be used to refine issuer messages, subsequent messaging, and ultimately trigger specific workflows. As an example, outbreaks or epidemics can be assessed using the present invention. Communities, schools, and governments can use the invention to survey populations through text messaging regarding an epidemic or pandemic and establish immediate workflows based on the responses received, such as awareness campaigns in real time, increasing healthcare provider access, and providing recommendations to minimize the spread of the disease or illness based on geographic location while maintaining the privacy of individuals.

An alternative embodiment of the invention disclosed herein, is the use in cellular Internet of Things (IoT). By reducing the compute power and data transmission required by mobile devices, mobile devices can be integrated into hardware more easily enabling users to provide input via text message using low-cost cellular services. Smart thermometers, as an example, could integrate this invention to combine temperature data with symptomatic information entered by the user. Another example is a car company such as Tesla that uses over the air software updates—a mobile device could be integrated into the car to provide users a method of communication back to the car company as well as other car owners. The car company could ask a question about the latest software update to the car, all car owners with the integrated mobile device could text back their response, and the aggregated responses could be shared with the entire audience all using minimal data and bandwidth as the processing would occur at the host.

An alternative embodiment of the invention disclosed herein may be used to aggregate various types of data including words, numbers, and emojis. In addition to words and numbers, emojis provide an opportunity to assess the emotional state of respondents efficiently, which can be most effective for the purpose of surveys the issuer seeks to assess the emotional state of respondents before issuing any workflow enrollment activities.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicant has grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A method for automated workflow processing, comprising:
a computing system with one or more processors performing the steps of:
receiving a plurality of criteria that defines an event;
generating a request eliciting participation by a plurality of persons in said event based on said plurality of criteria;
sending said request to a first plurality of mobile devices for said plurality of persons eliciting responses regarding said event, wherein said request is sent using one or more text messaging protocols;
receiving a plurality of responses to said request from a second plurality of mobile devices for a plurality of respondents comprising some or all of said first plurality of mobile devices wherein said plurality of responses are sent using said one or more text messaging protocols;
analyzing said plurality of responses and identifying data responsive to said request for each of the plurality of responses;
storing the data responsive to said request for each of the plurality of responses in a data storage system;
comparing the data responsive to said request for each of the plurality of responses with said plurality of criteria for said event and determining which, if any, of said criteria for said event have been met and storing the determinations in a memory;
performing one or more workflows when a predetermined number of said criteria for said event have been met based on said determinations; and
sending one or more messages related to said performance of said one or more workflow communications to said plurality of respondents.

2. The method of claim 1, wherein said one or more text messaging protocols include one or more of Short Message Service (SMS), Multimedia Messaging Service (MMS), Rich Communication Services (RCS), and Over-the-Top service (OTT).

3. The method of claim 1, further comprising receiving one or more queries from one or more of the plurality of respondents regarding said event.

4. The method of claim 3, further comprising responding to said one or more queries from said one or more of the plurality of respondents.

5. The method of claim 4, wherein said one or more text messaging protocols include one or more of Short Message Service (SMS), Multimedia Messaging Service (MMS), Rich Communication Services (RCS), and Over-the-Top service (OTT).

6. The method of claim 2, wherein said step of performing one or more workflows further comprises determining when one or more thresholds for said event have been met or exceeded.

7. The method of claim 3, further comprising analyzing said data responsive to said request for each of the plurality of responses and one or more results of performing said one or more workflows; and
producing analytical results and triggering one or more messages with said analytical results to said plurality of respondents.

8. A system for automated workflow processing comprising:
a computing system with one or more processors receiving a plurality of criteria that defines an event and generating a request eliciting participation by a plurality of persons in said event based on said plurality of criteria, further comprising:
one or more network interfaces sending said request to a first plurality of mobile devices for said plurality of persons eliciting responses regarding said event, wherein said request is sent to one or more text messaging networks using one or more text messaging protocols and receiving a plurality of responses to said request from a second plurality of mobile devices for a plurality of respondents comprising some or all of said first plurality of mobile devices wherein said plurality of responses are sent using said one or more text messaging protocols;
an analysis module analyzing said plurality of responses and identifying data responsive to said request for each of the plurality of responses;
a data storage system storing the data responsive to said request for each of the plurality of responses;
a decision module comparing the data responsive to said request for each of the plurality of responses with said plurality of criteria for said event and determining which, if any, of said criteria for said event have been met;
a memory for storing the determinations of the decision module;
a workflow module performing one or more workflows when a predetermined number of said criteria for said event have been met based on said determinations; and
a messaging interface sending one or more messages related to said performance of said one or more workflow communications to said plurality of respondents over said one or more network interfaces.

9. The system of claim 8, wherein said one or more text messaging protocols include one or more of Short Message Service (SMS), Multimedia Messaging Service (MMS), Rich Communication Services (RCS), and Over-the-Top service (OTT).

10. The system of claim 9, further comprising a query module receiving one or more queries from one or more of the plurality of respondents regarding said event.

11. The system of claim 10, said query module further responding to said one or more queries from said one or more of the plurality of respondents.

12. The system of claim 11, wherein said one or more text messaging protocols include one or more of Short Message Service (SMS), Multimedia Messaging Service (MMS), Rich Communication Services (RCS), and Over-the-Top service (OTT).

13. The system of claim 11, said workflow module further performing one or more workflows further comprises determining when one or more thresholds for said event have been met or exceeded.

14. The system of claim 10, said workflow module further analyzing said data responsive to said request for each of the plurality of responses and one or more results of performing said one or more workflows; and
producing analytical results and triggering one or more messages with said analytical results to said plurality of respondents using said messaging interface.

15. A tangible, non-transitory, machine-readable medium storing instructions that when executed by one or more processors effectuate operations comprising:
receiving a plurality of criteria that defines an event;
generating a request eliciting participation by a plurality of persons in said event based on said plurality of criteria;
sending said request to a first plurality of mobile devices for said plurality of persons eliciting responses regarding said event, wherein said request is sent using one or more text messaging protocols;
receiving a plurality of responses to said request from a second plurality of mobile devices for a plurality of respondents comprising some or all of said first plurality of mobile devices wherein said plurality of responses are sent using said one or more text messaging protocols;
analyzing said plurality of responses and identifying data responsive to said request for each of the plurality of responses;
storing the data responsive to said request for each of the plurality of responses in a data storage system;
comparing the data responsive to said request for each of the plurality of responses with said plurality of criteria for said event and determining which, if any, of said criteria for said event have been met and storing the determinations in a memory;
performing one or more workflows when a predetermined number of said criteria for said event have been met based on said determinations; and
sending one or more messages related to said performance of said one or more workflow communications to said plurality of respondents.

16. The medium of claim 15, wherein said one or more text messaging protocols include one or more of Short Message Service (SMS), Multimedia Messaging Service (MMS), Rich Communication Services (RCS), and Over-the-Top service (OTT).

17. The medium of claim 16, the operations further comprising receiving one or more queries from one or more of the plurality of respondents regarding said event.

18. The medium of claim 17, the operations further comprising responding to said one or more queries from said one or more of the plurality of respondents.

19. The medium of claim 18, wherein said operation of performing one or more workflows further comprises determining when one or more thresholds for said event have been met or exceeded.

20. The medium of claim 17, the operations further comprising analyzing said data responsive to said request for each of the plurality of responses and one or more results of performing said one or more workflows; and
producing analytical results and triggering one or more messages with said analytical results to said plurality of respondents.
